(19) United States
(12) Patent Application Publication
(10) Pub. No.: US 2012/0118116 A1
(43) Pub. Date: May 17, 2012

(54) APPARATUS AND METHOD FOR CUTTING A HOLE HAVING A PREDETERMINED SHAPE AND SIZE IN A DOOR PANEL

(76) Inventor: Mark E. Mulrine, Easton, PA (US)

(21) Appl. No.: 12/945,682

(22) Filed: Nov. 12, 2010

(51) Int. Cl. G01B 1/00; B26D 7/00

(52) U.S. Cl. 83/13; 33/565

(57) ABSTRACT

A device for guiding a tool to create a hole in a door panel. In one aspect, the invention can be an apparatus for guiding a tool to create a hole having a predetermined shape and size in a door panel, the apparatus comprising: an elongate member extending from a first end to a second end along a longitudinal axis, a bracket at the first end of the elongate member for engaging a top edge of the door panel; a template comprising a template section and a mounting section, the template section comprising a central opening defined by an inner edge, the central opening having the predetermined shape and size, the mounting section slidably mounted to the elongate member so that the template can be slid along the longitudinal axis of the elongate member; and a locking means for securing a position of the template on the elongate member.

### FIELD OF THE INVENTION

The present invention relates generally to an apparatus and method for cutting a hole in a panel, and more specifically to an apparatus and method for cutting a hole having a predetermined shape and size in a door panel of a locker.

### BACKGROUND OF THE INVENTION

There are approximately 75 million lockers in schools throughout the United States. The majority of these lockers are 30 to 50 years old and in serious need of repair or replacement. The average high school has 2,000 lockers. Locker handle repair is a never-ending task that wastes money and resources as experienced maintenance staff are diverted from performing more important tasks to try and repair a broken locker handle. Replacing their old, damaged lockers with new ones is financially impossible for most school districts. Replacement parts for these older locker doors are mostly expensive recycled parts that become more difficult to locate as the locker stock ages. The alternative is to just live with the problem and try to make repairs as needed.

The choice of methods currently being used to retrofit locker doors with new handles is quite limited. They are time consuming and use expensive, bulky equipment that require highly trained operators. The process of punching and cutting a hole into an installed locker requires extreme accuracy and skill. In cutting holes in the door panels of a bank of lockers, the holes must be in an identical location on the door panels of the lockers in order to keep the handles level and to achieve a satisfactory appearance.

One of the methods currently being used in the industry is to transport large, heavy hydraulic punch and die machines to the facility. This equipment sits on the floor positioned in front of a locker and, in a two-step process, punches a hole in the door. The cumbersome equipment is then moved a few inches to the next locker, re-leveled and the process is repeated. Another process is to transport a large punch press mounted in a trailer to the facility and set up outside of the building. Every locker door is then removed from the frame and carried outside to the trailer. Each door is then positioned on a hydraulic punch press and has a hole punched into it. Each door is then carried back inside the building and laboriously reattached to the locker frame. Both of the methods described can take anywhere from twenty to thirty minutes per door panel. If this process is used for an entire school full of lockers, which may contain upwards of two thousand (2,000) lockers, it can take more than sixty hours using multiple hydraulic presses and require considerable personnel.

Thus, a need exists for an apparatus and method for cutting a hole in a panel, specifically of a door panel.

Furthermore, a need exists for an apparatus and method that can cut a hole into a vertical panel, such as a door panel, without removing the panel from the remainder of the structure to which it is attached.

Additionally, a need exists for an apparatus and method that can be moved from one panel to another to cut holes in multiple panels without necessitating further adjustment of the apparatus.

### SUMMARY OF THE INVENTION

The present invention solves these and other needs by providing a template guide and method that provides a guide for cutting holes in pre-installed locker door panels without necessitating removal of the door panels from the lockers. While the invention is especially suitable for use in cutting holes in the door panels of lockers, the invention can be utilized to form holes in any type of panel or flat article, none of which are limiting of the present invention unless specifically recited in the claims.

In one aspect, the invention can be an apparatus for guiding a tool to create a hole having a predetermined shape and size in a door panel, the apparatus comprising: an elongate member extending from a first end to a second end along a longitudinal axis, a bracket at the first end of the elongate member for engaging a top edge of the door panel; a template comprising a template section and a mounting section, the template section comprising a central opening defined by an inner edge, the central opening corresponding to the predetermined shape and size, the mounting section slidably mounted to the elongate member so that the template can be slid along the longitudinal axis of the elongate member; and a locking means for securing a position of the template on the elongate member.

In another aspect, the invention can be an apparatus for guiding a tool to create a hole having a predetermined shape and size in a door panel, the apparatus comprising: an elongate member extending from a first end to a second end along a longitudinal axis, the elongate member having a front surface and a rear surface and at least one magnet coupled to and protruding from the rear surface; a bracket for engaging a top edge of the door panel extending from the rear surface of the elongate member at the first end of the elongate member; a template comprising a template section and a mounting section, the template section comprising a central opening defined by an inner edge, the central opening having the predetermined shape and size; the mounting section comprising a top surface and a bottom surface and having a dovetail channel extending from the top surface to the bottom surface that creates a longitudinal passageway through the mounting section, the dovetail channel comprising a receiving section for slidably receiving the elongate member and a slot section extending from a rear surface of the mounting section to the receiving section.

In a further aspect, the invention can be a method of creating a hole having a predetermined shape and size in a door panel, the method comprising: hanging an elongate member extending from a first end to a second end along a longitudinal axis from a top edge of the door panel by a bracket that extends from the first end of the elongate member; providing a template comprising a template section and a mounting section, the template section comprising a central opening defined by an inner edge, the mounting section comprising a top surface and a bottom surface and having a channel extending from the top surface to the bottom surface of the mounting section that creates a first longitudinal passageway through the mounting section; inserting the second end of the elongate member into the first longitudinal passageway of the mounting section; sliding the template along the longitudinal axis of the elongate member to a desired height; and cutting a hole in the door panel at the desired height by tracing the inner edge of the central opening with a cutting tool.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 is a front perspective view of a guide for forming a hole in a door panel according to one embodiment of the present invention;

FIG. 2 is a side view of the guide of FIG. 1;

FIG. 3 is a front view of the guide of FIG. 1 having measurement indicia thereon;

FIG. 4a is a rear perspective view of the template portion of the guide of FIG. 1;

FIG. 4b is a bottom view of the template portion of FIG. 4a;

FIG. 5a is a rear view of the guide of FIG. 1 with the template portion detached from the elongate member;

FIG. 5b is a rear view of the guide of FIG. 1 with the template portion slidably mounted on the elongate member, wherein the locking means is in a first position;

FIG. 5c is a rear view of the guide of FIG. 5b with the locking means in a second position;

FIG. 6 is a rear view of the guide of FIG. 5c with the template portion slidably mounted on the elongate member, and wherein a magnet on the elongate member is received within a slot of the template portion;

FIG. 7 is a schematic of the guide of FIG. 1 hanging from a door panel of a locker, when used to form a hole in the door panel according to an embodiment of the present invention;

FIG. 8 is a cross-sectional view taken along the line B-B in FIG. 7; and

FIG. 9 is a close-up view of area IX of FIG. 8.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

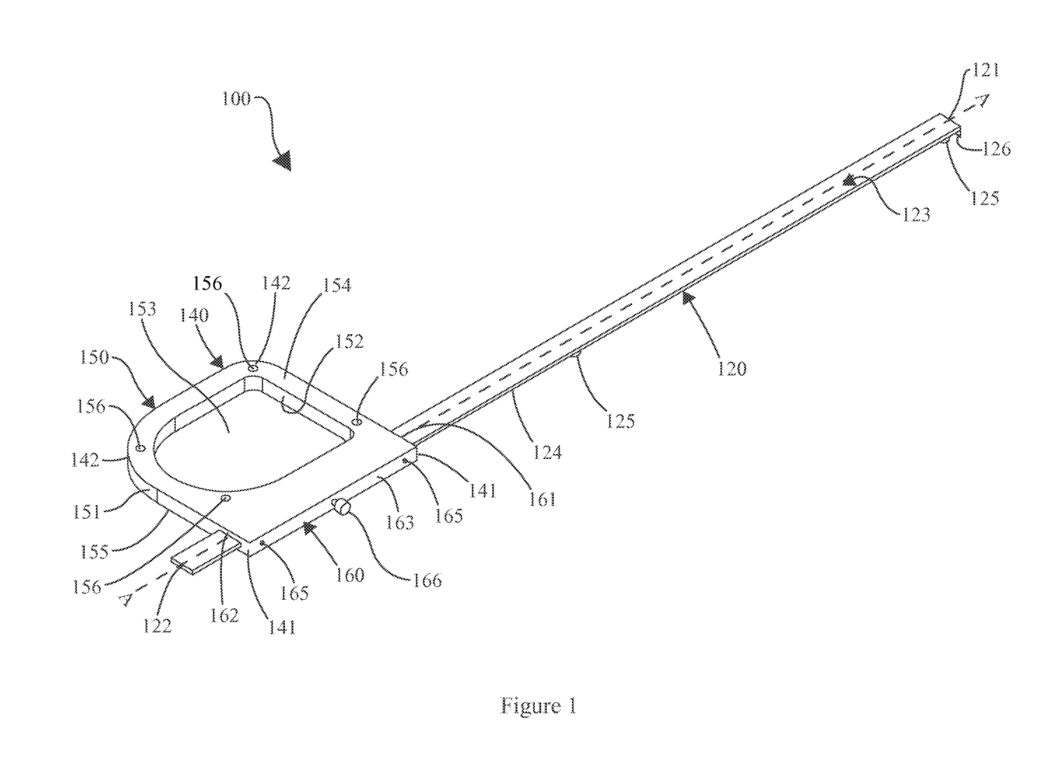

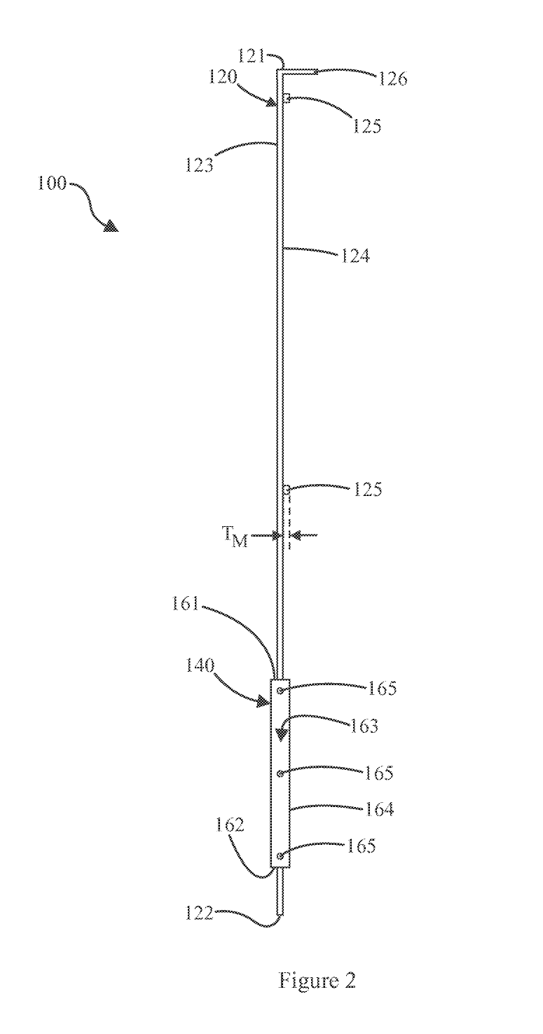

Referring to FIGS. 1 and 2 concurrently, an alignment guide 100 for guiding a tool to form a hole in a door panel is illustrated. The alignment guide 100 comprises an elongate member 120 and a template 140. The elongate member 120 extends from a first end 121 to a second end 122 along a longitudinal axis A-A. The elongate member 120 is illustrated as bar-like member having a rectangular transverse cross-section. However, the invention is not so limited and the elongate member 120 may take on many other shapes and sizes as would be understood by a person skilled in the art.

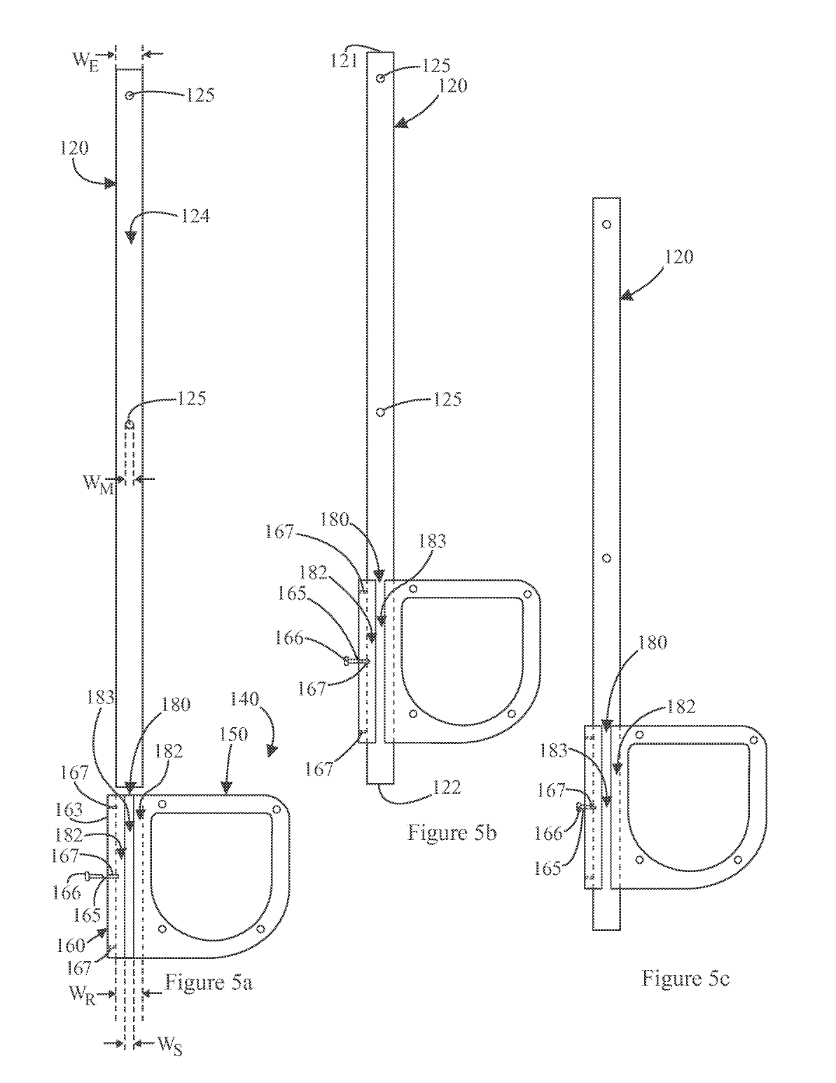

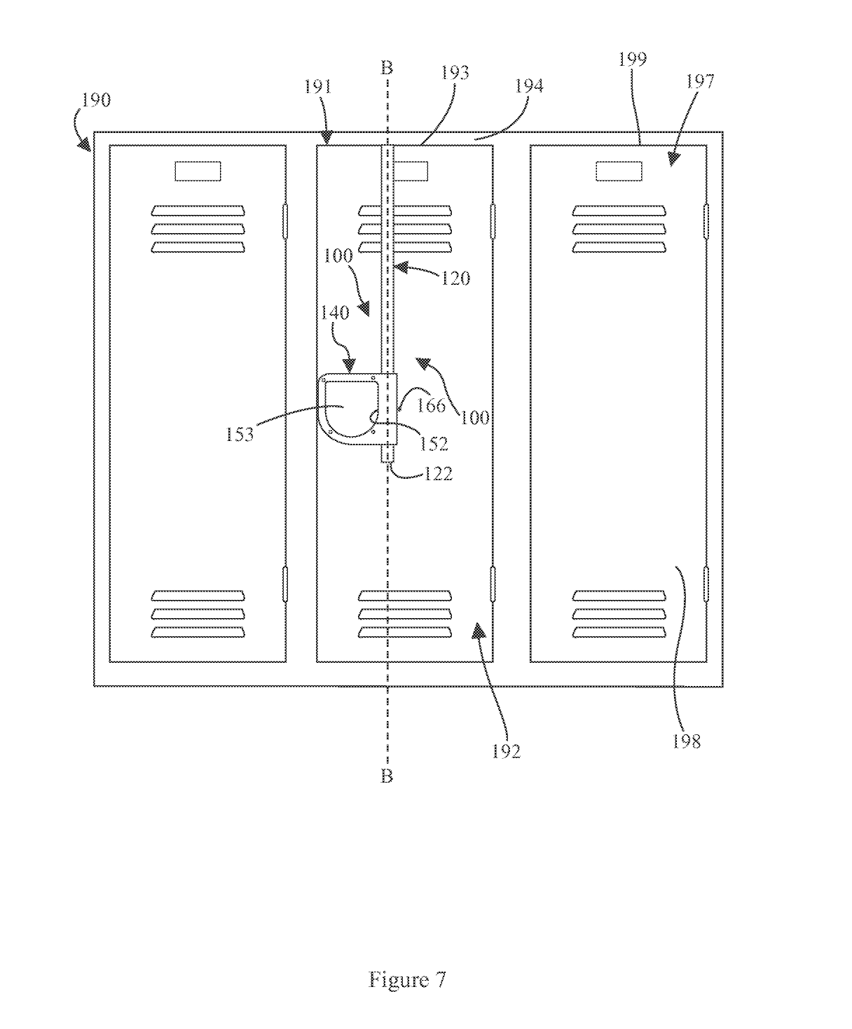

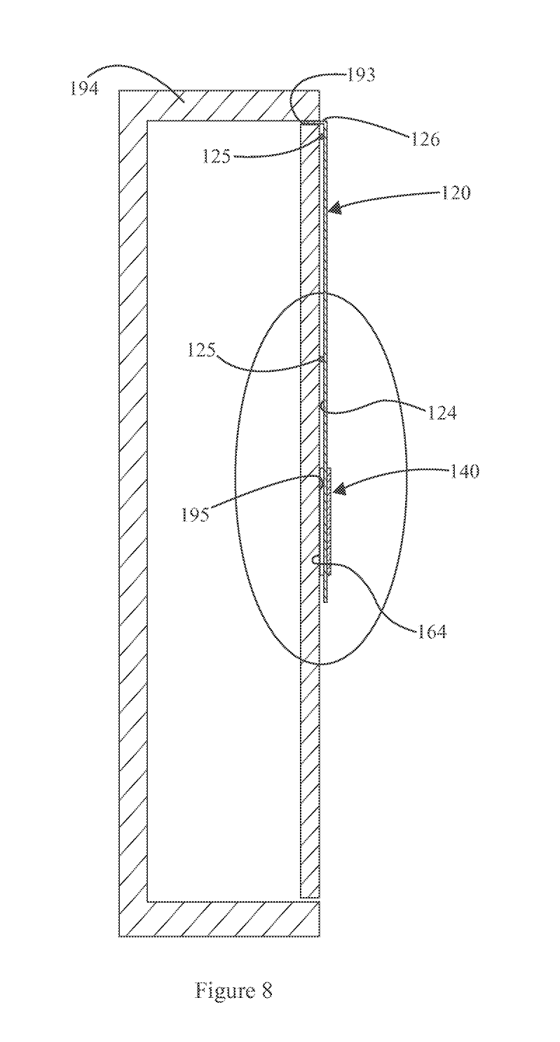

The elongate member 120 comprises a front surface 123 and a rear surface 124 opposite the front surface 123. The front and rear surfaces 123, 124 are preferably flat, planar surfaces so that the elongate member 120 can freely slide within the template 140, as will be described in detail below with reference to FIGS. 5a-5c. The first end 121 of the elongate member 120 comprises a bracket 126 extending rearwardly therefrom. More specifically, the bracket 126 extends from the rear surface 124 of the elongate member 120. The bracket 126 is used to hang the elongate member 120 from a door panel to be worked on, as will be described in more detail below with reference to FIGS. 7 and 8.

The elongate member 120 preferably has at least one magnet 125 coupled to and protruding from the rear surface 124. As will be described in more detail below, the magnet 125 provides additional integrity when securing the elongate member 120 to the door panel when the door panel is a material to which magnets area attracted (i.e., magnetic material), such as sheet metal formed from nickel, iron, cobalt, gadolinium or other ferromagnetic materials. In the illustrated embodiment, the elongate member 120 has two magnets 125 coupled to and protruding the rear surface 124. However, in some embodiments of the present invention, the magnets 125 may be omitted altogether and the bracket 126 alone may be used to mount the elongate member 120 to the door panel. In alternate embodiments, the magnets 125 may simply be one elongated strip of magnetic material coupled to the rear surface 124. In other embodiments, the rear surface 124 of the elongate member 120 (or portions thereof) may itself be formed of a magnetic material.

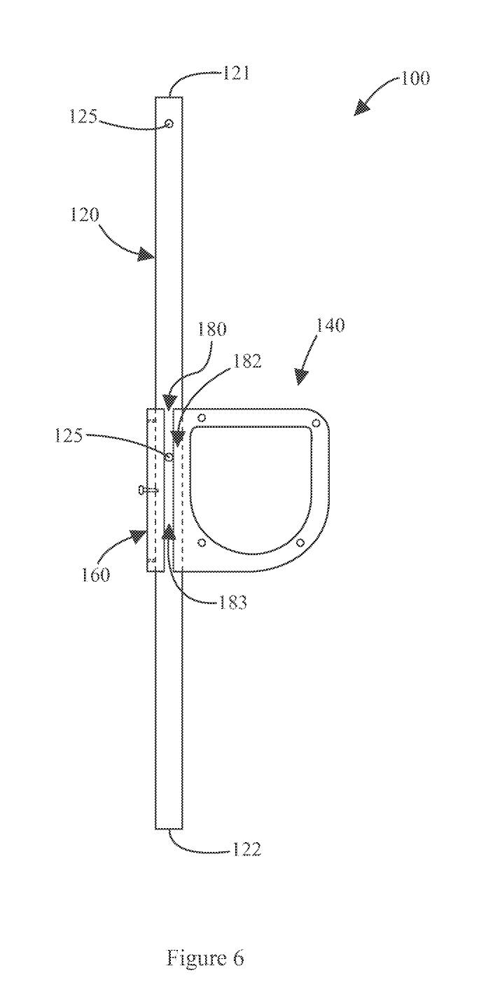

Referring solely to FIG. 2, the magnets 125 have a thickness T_{M}, which is the distance that the magnets 125 protrude from the rear surface 124 of the elongate member 120. The magnets 125 also have a width W_{M} (FIG. 5a), which is the transverse length of the magnets 125 across the elongate member 120. The importance of the width W_{M} and the thickness T_{M} of the magnets 125 will become apparent to a person skilled in the art based on the discussion below with reference to FIGS. 6 and 8.

Referring again to FIGS. 1 and 2 concurrently, the template 140 is illustrated as being a rectangular-shaped member having two right-angle corners 141 and two rounded corners 142, thereby resulting in the template 140 having a substantially D-shape. However, the template 140 may take on any other shape including a circle, triangle or other polygonal shape as would be known by persons skilled in the art.

The template 140 comprises a template section 150 and a mounting section 160. While the template 140 is conceptually described as including a template section 150 and a mounting section 160, the template 140 is preferably a unitary structure wherein the template section 150 and the mounting section 160 are integrally formed. Of course, in alternate embodiments, the template section 150 and the mounting section 160 could be formed of separate components that are connected together to form the template 140.

The template section 150 comprises an outer peripheral edge 151 and an inner edge 152. The inner edge 152 defines a central opening 153. The central opening 153 extends through the template section 150 from a front surface 154 of the template section 150 to a rear surface 155 of the template section 150, thereby forming a passageway therethrough. The central opening 153 is exemplified as having a U-shape. However, the invention is not so limited and the central opening 153 may take on any known shape.

As will be described in greater detail below with reference to FIG. 7, the inner edge 152 of the template section 150 is used as a guide for a tool to create a hole in a door panel having a size and shape that corresponds to the central opening 153. As such, the inner edge 152 of the template section 150 can take on a variety of different shapes (and sizes) to define the central opening 153. Preferably, the central opening 153 corresponds in size and shape to the size and shape a hole necessary to mount a desired handle to the door panel. During mounting, the handle will be placed over the hole that is formed using the guide 100 and secured thereto.

A plurality of apertures 156 are also provided in the template section 150 that extend from the front surface 154 to the rear surface 155, thereby forming passageways through the template section 150. In the illustrated embodiment of FIG. 1, four apertures 156 are shown. However, the invention is not to be limited by the number of apertures 156 and more or less than four apertures 156 may be used on the template section 150 as desired. The apertures 156 in the template section 150 are provided to enable screw holes to be formed into the door panel for securing the handle to the door panel. Typical locker handles require four screws for proper attachment to the door panel. However, not all locker handles require four screws and other numbers of apertures 156 can be provided accordingly. Furthermore, in certain embodiments, the template section 150 may not include any apertures 156.

Referring to FIGS. 1, 2, 4a and 4b concurrently, the mounting section 160 comprises a top surface 161, a bottom surface 162, a side surface 163 and a rear surface 164. The top surface 161, bottom surface 162, and side surface 163 of the mounting section 160, in conjunction with the outer peripheral edge 151 of the template section 150, collectively form a continuous perimetric edge of the template 140. The rear surface 164 of the mounting section 160, in conjunction with the rear surface 155 of the template section 150, collectively form a continuous planar rear surface of the template 140. Similarly, the front surface 154 of the mounting section 160, in conjunction with the front surface (not numbered) of the template section 150, collectively form a continuous planar rear surface of the template 140. Of course, the invention is not so limited and the front and/or rear surfaces of the template 140 may be stepped and/or non-coplanar if desired.

The mounting section 160 further comprises a dovetail channel 180 formed therein that extends from the top surface 161 of the mounting section 160 to the bottom surface 162 of the mounting section 160, thereby forming a longitudinal passageway through the mounting section 160. The dovetail channel 180 conceptually comprises a receiving section 182 and a slot section 183. The receiving section 182 is sized and configured to slidably receive the elongate member 120 and forms a portion of the longitudinal passageway extending through the mounting section 160. In one embodiment, the receiving section 182 has a transverse cross-sectional profile that corresponds to the transverse cross-sectional profile of the elongate member 120. The slot section 183 extends from the receiving section 182 to the rear surface 164 of the mounting section 160. The slot section 183 is coextensive with the receiving section 182 and, thus, also forms a portion of the longitudinal passageway through the mounting section 160. However, by virtue of the slot section 183 extending to the rear surface 164, the slot section 160 also forms a transverse passageway from the rear surface 164 into the receiving section 182. The slot section 183 has a width that is smaller than a width of the receiving section 182.

Although the dovetail channel 180 is exemplified as being a T-shaped channel, the invention is not so limited. As used herein, the term dovetail channel 180 includes any type of channel having a receiving section and a slot section where the slot section has a longitudinal center line as long as the receiving section extends further from the longitudinal centerline than the slot section in at least one direction. As such, the dovetail channel 180 can be an L-shaped channel, a V-shaped channel, a T-shaped channel, or combinations thereof, even if the slot section 183 is offset with respect to the center of the receiving section 182. Stated simply, the dovetail channel 180 can take on a wide variety of cross-sectional profiles, so long as the elongate member 120 is transversely retained within the dovetail channel 180 once it is slid therein in the longitudinal direction.

A plurality of openings 165 are provided in the side surface 163 of the mounting section 160. Each of the openings 165 forms a transverse passageway from the side surface 163 of the mounting section 160 into the receiving section 182 of the dovetail channel 180. The openings 165 are provided to receive a mechanism to lock the position of the template 140 along the elongate member 120, such as a set screw. This will be described in greater detail below with respect to FIGS. 5a-5c. While three passageways 165 are exemplified, more or less than three passageways/openings 165 can be provided as desired. In alternate embodiments, depending on the type of locking mechanism used, the openings 165 may be omitted and/or unnecessary.

Referring now to FIG. 5a, each opening 165 forms a transverse passageway 167 from the side surface 163 of the mounting section 160 to the dovetail channel 180, and more particularly to the receiving section 182 of the dovetail channel 180. A locking mechanism 166 is positioned within the transverse passageway 167 for securing a position of the template 140 on the elongate member 120 as will be described in more detail below with specific reference to FIGS. 5a-5c. The locking mechanism 166 may be any one of a set screw, a butterfly screw, a knob, a spring loaded element, a clamp and a latch.

If the locking mechanism 166 is a set screw, butterfly screw or any other type of threaded screw, then the transverse passageway 167 will comprise complementary threads to enable the locking mechanism 166 to be inserted and threadily engaged therein. In alternate embodiments, the locking mechanism may take the form of a spring loaded element that is retained within the passageway 167 and biased into contact with the elongate member 120. As used herein, the term “spring loaded element” includes type of element that is attached to a spring, or other resilient member, so that the element is biased into contact with the elongate member 120, such that the template 140 is unable to move along the elongate member 120 until a counter-force, such as a pulling force, is applied to the element. Examples of spring loaded elements include a spring-loaded pin, a probe, a clamp, or any other type of element that is known. In further alternate embodiments, the locking mechanism can be a clamp, a vice, a cotter pin, a tight fit assembly, and/or combinations thereof.

Referring now to FIGS. 5a-5c concurrently, the mounting or attachment between the elongate member 120 and the template 140 will be described. As illustrated in FIG. 5a, the elongate member 120 and the template 140 are two separate and distinct components. In use, the second end 122 of the elongate member 120 is longitudinally aligned with the receiving section 182 of the dovetail channel 180. A width W_{E} of the elongate member 120 is substantially equal to a width W_{R} of the receiving section 182 of the dovetail channel 180.

In one embodiment, both the width W_{E} of the elongate member 120 and the width W_{R} of the receiving section 182 are preferably between 18 and 26 mm, and more preferably between 21 and 24 mm. However, it should be understood that the width W_{R} of the receiving section 182 of the dovetail channel 180 is preferably slightly larger than the width W_{E} of the elongate member 120 so as to provide for the necessary tolerance so that the elongate member 120 can be accommodated within the receiving section 182 For example, the width W_{R} of the receiving section 182 of the dovetail channel 180 is preferably between 0.05 and 0.7 mm larger than the width W_{E} of the elongate member 120. The difference between the width W_{R} of the receiving section 182 of the dovetail channel 180 and the width W_{E} of the elongate member 120 enables the template 140 to freely slide along the longitudinal axis A-A of the elongate member 120. In a most preferable embodiment, the width W_{E} of the elongate member 120 is between 22.5 and 22.8 mm and the width W_{R} of the receiving section 182 is between 23.1 and 23.3 mm. Of course, if the width W_{E} of the elongate member 120 is increased, and there is no limit to what the width W_{E} of the elongate member 120 can be, the width W_{R} of the receiving section 182 will be increased accordingly to ensure that the elongate member 120 can be slidably'received within the receiving section 182 and the template 140 can freely slide along the longitudinal axis A-A of the elongate member 120.

Still referring to FIG. 5a, the width W_{M} of the magnet 125 is preferably substantially equal or less than a width W_{S} of the slot section 183 of the dovetail channel 180. In one embodiment, both the width W_{M} of the magnet 125 and the width W_{S} of the slot section 183 are preferably between 3 and 6 mm, and more preferably between 4 and 5 mm. Although the width W_{M} of the magnet 125 and the width W_{S} of the slot section 183 are described as being substantially equal in the preferred embodiment, one skilled in the art should understand that the width W_{S} of the slot section 183 should be slightly larger than the width W_{M} of the magnet 125 to enable the magnet 125 to slide within the slot section 183 as described in more detail below with reference to FIG. 6. The width W_{M} of the magnet 125 is the diameter of the magnet 125 when the magnet 125 is cylindrical-shaped.

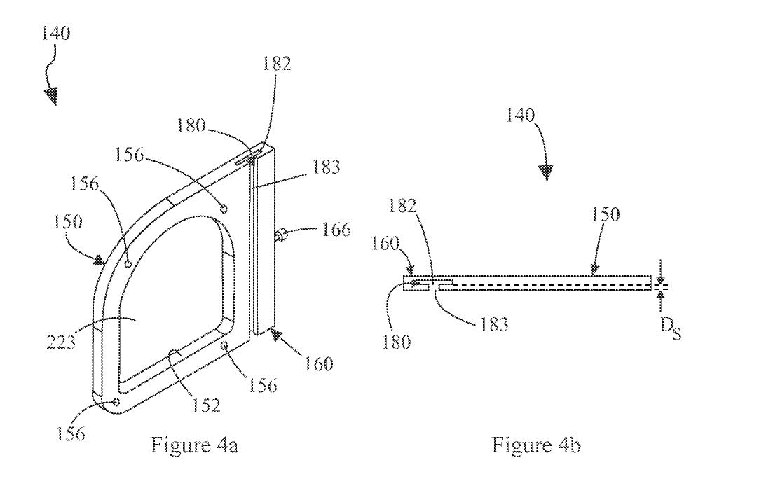

Furthermore, a depth D_{S} of the slot section 183 (FIG. 4b) is preferably greater than or equal to the thickness T_{M} (FIG. 2) of the magnet 125 (i.e., the distance that the magnet 125 protrudes from the rear surface 124 of the elongate member 120). The depth D_{S} of the slot section is preferably between 4.4 and 5 mm and the thickness T_{M} of the magnet 125 is sized to fit therein accordingly. The sizes of the magnet 125 and the slot section 183 of the dovetail channel 180 are such as to allow the magnet 125 to freely fit and slide longitudinally within and through the slot section 183 when the template 140 is slid along the longitudinal axis A-A of the elongate member 120, as will be discussed in more detail below with reference to FIG. 6.

Referring now to FIG. 5b, the mounting section 160 of the template 140 is illustrated in mounting engagement with the elongate member 120. In order to get into the illustrated position, the second end 122 of the elongate member 120 is slid into the receiving section 182 of the dovetail channel 180. During this insertion, the locking mechanism 166 is in a first position, in which the locking mechanism 166 is not fully inserted through the transverse passageway 167. When the locking mechanism 166 is in the first position, the locking mechanism does not contact the elongate member 120 and thus does not interfere with the movement of the elongate member 120 within the retaining section 182 of the dovetail channel 180. As such, the template 140 is free to slide in an unrestricted manner along the longitudinal axis A-A of the elongate member 120.

Referring now to FIG. 5c, the mounting section 160 of the template 140 is still in mounting engagement with the elongate member 120, as shown in FIG. 5b and described above. However, in FIG. 5c, the locking mechanism 166 has been adjusted to be in a second position in which the locking mechanism 166 is fully inserted into the transverse passageway 167 and extends into the receiving section 182 of the dovetail channel 180. As a result, the locking mechanism 166 contacts the elongate member 120 in the second position When in the second position, the locking mechanism 166 prohibits (or restricts) movement of the template 140 along the longitudinal axis A-A of the elongate member 120.

Referring now to FIG. 6, the mounting section 160 of the template 140 is illustrated in mounting engagement with the elongate member 120 (similar to that which is described above with reference to FIGS. 5b and 5c). However, in FIG. 6, the template 140 is positioned closer to the first end 121 of the elongate member 120 so that at least one of the magnets 125 is positioned within the slot section 183 of the dovetail channel 180. FIG. 6 exemplifies the importance of the slot section 183 in that it allows the template 140 to be able to slide up and down the entire longitudinal length of the elongate member 120. Thus, if a hole was required to be cut at a higher elevation on a door panel, the template guide 100 would be fully capable of doing so while still allowing the magnets 125 to remain engaged to the door panel.

Furthermore, the template guide 100 could be used as a guide for cutting holes in small, stackable lockers. The bracket 126 of the elongate member 120 could be hung from the top edge of the top locker in a stack of lockers. The template 140 can be positioned towards the second end 122 of the elongate member 120 so that a hole can be cut in the door panel of the bottom locker in a stack of lockers. Then, the template 140 can be slid towards the first end 121 of the elongate member 120 so that a hole can be cut in the door panel of the top locker in the stack of lockers.

Referring to FIG. 7, a set of three lockers 190 is illustrated having the template guide 100 hanging from a top edge 193 of a door panel 192 of one of the lockers 191. The entirety of the template guide 100, including the template 140 and the elongate member 120, is preferably made of a plastic material, such as a polycarbonate or other thermoplastic polymer. However, the invention is not so limited and the template guide 100 may be formed of a metal such as, without limitation, iron, steel or nickel. When the template guide 100 is formed of a plastic material, it is lightweight, easily maneuverable and less expensive to manufacture than metal, making it an ideal material for the template guide 100.

Referring to FIGS. 7 and 8 concurrently, the hanging of the template guide 100 from the top edge 193 of the door panel 192 will be described in more detail. The bracket 126 of the elongate member 120 is positioned between the top edge 193 of the door panel 192 and the frame 194 of the locker 191. In this position, the elongate member 120, with the template 140 mounted thereon, is able to hang from the top edge 193 of the door panel 192.

As can be seen, when the bracket 126 is engaged to the top edge 193 of the door panel 192, the rear surface 164 of the mounting section 160 (and the entire rear surface of the template 140) is in surface contact with a front surface 195 of the door panel 192. This flush contact enables the inner surface 152 of the template section 150 of the template 140 to easily be traced with a cutting tool so as to cut a hole the size and shape of the central opening 153 of the template section 150 in the door panel 192.

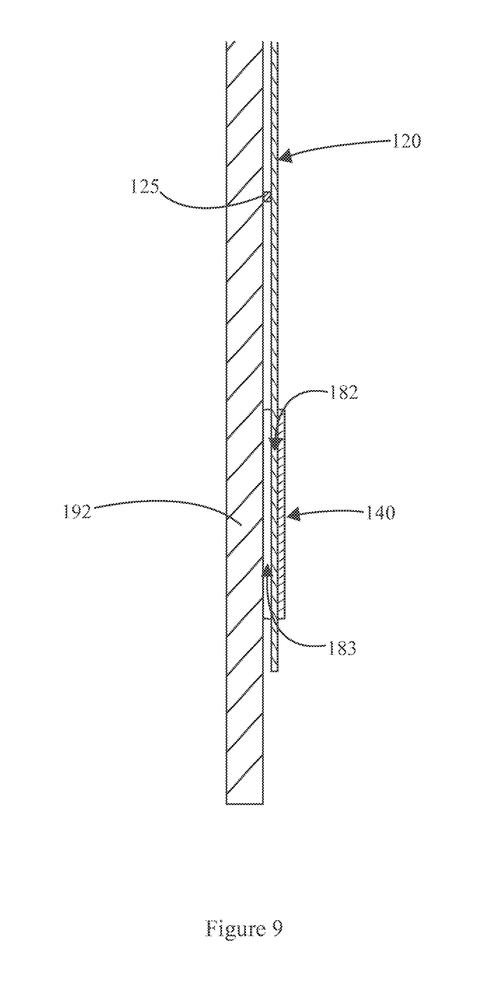

Furthermore, when the bracket 126 is engaged to the top edge 193 of the door panel 192, the magnets 125 are also in surface contact with a front surface 195 of the door panel 192. The magnets 125 provide a more secure attachment between the template guide 100 and the magnetic front surface 195 of the door panel 192. Referring to FIGS. 8 and 9 concurrently, in some embodiments, the thickness T_{M} of the magnets 125 is equal to the distance between the rear surface 124 of the elongate member 120 and the rear surface 164 of the mounting section 160. As such, the magnets 125 are able to provide a secure attachment between the template guide 100 and the front surface 195 of the door panel 192 while the template 140 rests flush against the front surface 195 of the door panel 192 to make it easy for the installer to trace the inner surface 152 of the template section 150 with a cutting tool to cut a hole the size and shape of the central opening 153 of the template section 150.

With reference to FIGS. 7-9, a method of cutting a hole having a predetermined shape and size in a door panel will be described. The elongate member 120 is hung from the top edge 193 of the door panel 192 by the bracket 126 of the elongate member 120. Once the elongate member 120 is hanging from the door panel 192, the template 140 is mounted on the elongate member 120 by sliding the second end 122 of the elongate member 120 into the receiving section 182. The template 140 is then slid upwards and downwards along the longitudinal axis A-A of the elongate member 120 until a desired vertical height has been reached. The desired height is reached when the central opening 153 of the template 140 is positioned where the hole is to be cut, and hence, where the handle is to eventually be placed on the door panel 192.

Once the desired height has been achieved, the locking means 166 is positioned within the transverse passageway 167 and put into the second position to prohibit the template 140 from sliding along the longitudinal axis A-A of the elongate member 120. The elongate member 120 is then horizontally aligned on the door panel 192 so that the central opening 153 is aligned with a desired horizontal cutting position. After alignment a cutting tool, such as, without limitation, a cutting torch, a saw, a nibbler, a laser, a water jet or other tool is used to cut a hole the size and shape of the central opening 153 into the door panel 192.

After the first hole is cut, the template guide 100 is removed from the door panel 192 by removing the bracket 126 from the top edge 193 of the door panel 192. The template guide 100 can then be moved to another locker, such as locker 197. At this point, the template guide 100 is already properly vertically aligned. Thus, the template guide 100 need only be connected to the door panel 198 of the locker 197 by attaching the bracket 126 of the elongate member 120 to the top edge 199 of the door panel 198 and then horizontally aligning the template guide 100 on the locker 197. After alignment, a hole can be cut in the door panel 198 in the same manner as described above with reference to door panel 192. This process can continue until all of the door panels that need holes cut into them for the installation of handles has been completed. This method significantly speeds up the process of cutting holes into locker door panels for the installation of handles.

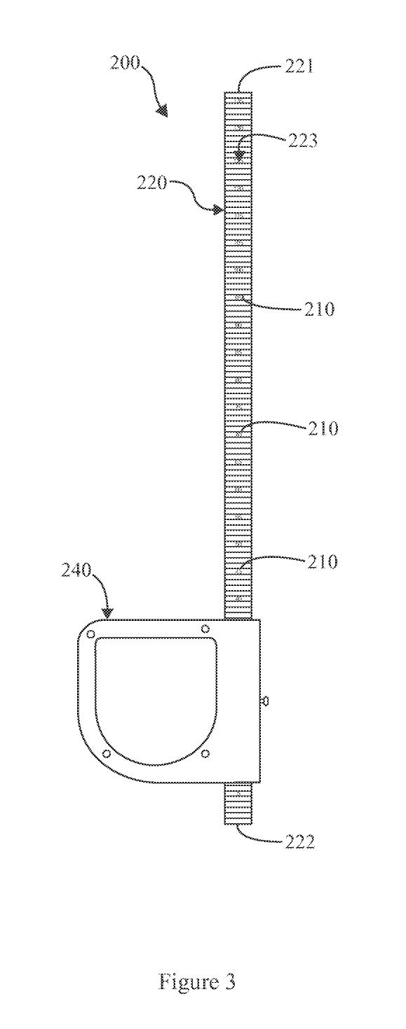

Referring to FIG. 3, an alignment guide 200 is illustrated. The same reference numerals used to describe the alignment guide 100 will be used to describe the alignment guide 200 except that the 200-series of numbers will be used. The alignment guide 200 is identical to the alignment guide 100 with the exception of having measurement indicia 210 on the front surface 223 of the elongate member 220. The measurement indicia 210 are essentially the markings of a ruler and the measurement indicia 210 are preferably imprinted directly onto the front surface 223 of the elongate member 220. The measurement indicia 210 can be carved into the front surface 223 of the elongate member 220 during or after manufacturing of the elongate member 220 or the measurement indicia 210 can be adhesively or otherwise applied to the front surface 223 of the elongate member 220 and only used as needed. Of course, other methods of placing measurement indicia 210 onto the front surface 223 of the elongate member 220 can be used as would be known to persons skilled in the art.

The measurement indicia 220 enable an installer who is cutting a hole in a door panel to ensure that the proper or desired cutting height is achieved and maintained prior to cutting the hole. Furthermore, if holes must be cut into multiple door panels, the user can easily ensure that the template 240 is not sliding upwardly or downwardly along the longitudinal axis A-A of the elongate member 220 when moving the alignment guide 200 between the different door panels. Although the numbering on the measurement indicia 210 is illustrated having the lower numbers towards the second end 222 of the elongate member 220 and the higher numbers towards the first end 221 of the elongate member 220, the invention is not so limited. In alternate embodiments, the lower numbers are nearest the first end 221 so that the proper or desired height at which to cut the hole can be determined as a distance from a top edge of a door panel.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. An apparatus for guiding a tool to create a hole having a predetermined shape and size in a door panel, the apparatus comprising:
an elongate member extending from a first end to a second end along a longitudinal axis, a bracket at the first end of the elongate member for engaging a top edge of the door panel;
a template comprising a template section and a mounting section, the template section comprising a central opening defined by an inner edge, the central opening corresponding to the predetermined shape and size, the mounting section slidably mounted to the elongate member so that the template can be slid along the longitudinal axis of the elongate member; and
a locking means for securing a position of the template on the elongate member.

2. The apparatus of claim 1 wherein the elongate member further comprises a front surface having measurement indicia.

3. The apparatus of claim 1 wherein the elongate member further comprises a front surface and a rear surface and at least one magnet coupled to and protruding from the rear surface of the elongate member.

4. The apparatus of claim 3 wherein the magnet extends a first distance from the rear surface of the elongate member and the mounting section extends a second distance from the rear surface of the elongate member when the template is mounted to the elongate member, the first and second distances being substantially equal.

5. The apparatus of claim 1 wherein the mounting section has a top surface, a bottom surface and a side surface and a channel extending from the top surface to the bottom surface of the mounting section that creates a longitudinal passageway through the mounting section.

6. The apparatus of claim 5 wherein the longitudinal passageway slidably receives the second end of the elongate member.

7. The apparatus of claim 5 wherein the mounting section further comprises a transverse passageway extending from the side surface of the mounting portion to the longitudinal passageway, and wherein the locking means comprises at least one of a set screw, a butterfly screw, a knob, a spring loaded element, a clamp and a latch.

8. The apparatus of claim 5 wherein the mounting section further comprises a rear surface having a longitudinal slot and wherein the longitudinal slot extends from the rear surface of the mounting section to the first longitudinal passageway, the longitudinal slot being coextensive with the channel.

9. The apparatus of claim 8 further comprising at least one magnet coupled to and protruding from the rear surface of the elongate member, wherein the longitudinal slot slidably receives the magnet when the template is slid along the longitudinal axis of the elongate member.

10. The apparatus of claim 1 wherein the locking means is adjustable from a first position that allows the template to freely slide along the longitudinal axis of the elongate member to a second position that prohibits the template from sliding along the longitudinal axis of the elongate member.

11. An apparatus for guiding a tool to create a hole having a predetermined shape and size in a door panel, the apparatus comprising:
an elongate member extending from a first end to a second end along a longitudinal axis, the elongate member having a front surface and a rear surface and at least one magnet coupled to and protruding from the rear surface;
a bracket for engaging a top edge of the door panel extending from the rear surface of the elongate member at the first end of the elongate member;
a template comprising a template section and a mounting section, the template section comprising a central opening defined by an inner edge, the central opening corresponding to the predetermined shape and size;
the mounting section comprising a top surface and a bottom surface and having a dovetail channel extending from the top surface to the bottom surface that creates a longitudinal passageway through the mounting section, the dovetail channel comprising a receiving section for slidably receiving the elongate member and a slot section extending from a rear surface of the mounting section to the receiving section.

12. The apparatus of claim 11 wherein the slot section slidably receives the magnet when the template is slid along the longitudinal axis of the elongate member.

13. The apparatus of claim 12 wherein the slot section has a depth measured from the rear surface of the mounting section to the receiving section and wherein the depth of the slot section is greater than or equal to a distance which the magnet protrudes from the rear surface of the mounting section.

14. The apparatus of claim 11 further comprising two cylindrical shaped magnets coupled to and protruding from the rear surface of the elongate member in a spaced apart manner, wherein a diameter of the cylindrical shaped magnets is less than or equal to a width of the slot section.

15. The apparatus of claim 11 wherein the slot section has a depth measured from the rear surface of the mounting section to the receiving section and wherein the depth of the slot section is greater than or equal to a distance which the magnet protrudes from the rear surface and wherein the magnet and the rear surface of the mounting section are in simultaneous contact with the door panel when the template is mounted to the elongate member and the bracket is engaged with the top edge of the door panel.

16. The apparatus of claim 11 wherein a width of the magnet is less than or equal to a width of the slot section to allow the slot section to slidably receive the magnet when the template is slid along the longitudinal axis of the elongate member and wherein the width of the magnet is less than a width of the elongate member.

17. A method of creating a hole having a predetermined shape and size in a door panel, the method comprising:
hanging an elongate member extending from a first end to a second end along a longitudinal axis from a top edge of the door panel by a bracket that extends from the first end of the elongate member;
providing a template comprising a template section and a mounting section, the template section comprising a central opening defined by an inner edge, the mounting section comprising a top surface and a bottom surface and having a channel extending from the top surface to the bottom surface of the mounting section that creates a longitudinal passageway through the mounting section;
inserting the second end of the elongate member into the longitudinal passageway of the mounting section;
sliding the template along the longitudinal axis of the elongate member to a desired height; and
cutting a hole in the door panel at the desired height by tracing the inner edge of the central opening with a cutting tool.

18. The method of claim 17 further comprising securing the elongate member to the door panel by at least one magnet connected to a rear surface of the elongate member, the magnet and the template being in simultaneous surface contact with a front surface of the door panel when the second end of the elongate member is inserted into the longitudinal passageway of the mounting section.

19. The method of claim 18 wherein the mounting section further comprises a rear surface having a longitudinal slot that extends from the rear surface of the mounting section to the longitudinal passageway, the longitudinal slot being coextensive with the channel, the longitudinal slot receiving the magnet when the template is slid along the longitudinal axis of the elongate member.

20. The method of claim 17 further comprising adjusting a locking means from a first position that allows the template to freely slide along the longitudinal axis of the elongate member to a second position that prohibits the template from sliding along the longitudinal axis of the elongate member.
